(19) United States
(12) Patent Application Publication
(10) Pub. No.: US 2018/0147512 A1
(43) Pub. Date: May 31, 2018

(54) Air Venting Device for a Filter

(71) Applicants: Robert Bosch GmbH, Stuttgart (DE); Robert Bosch Engineering and Business Solutions Private Limited, Bangalore (IN)

(72) Inventors: Deepak Kumar Chinnathambi, Salem (IN); Munivel Ackumari, Karimangalam (IN); Navaneetha Krishnan Rathinam, Karamadai (IN); Suresh Kumar Palanisamy, Ranagasamudram (IN); Thangadurai Shanmugam, Erode (IN); Albrecht Oedekoven, Ludwigsburg (DE)

(21) Appl. No.: 15/824,246

(22) Filed: Nov. 28, 2017

(30) Foreign Application Priority Data
Nov. 30, 2016 (IN) 201641040878

(51) Int. Cl. B01D 36/00; B01D 29/92; F02M 37/22; F02M 37/20

(52) U.S. Cl. CPC B01D 36/001; B01D 29/925; F02M 37/20; F02M 37/22; B01D 36/008

(57) ABSTRACT

An air venting device for a filter includes a flow path, a frame, a flexible element, a movable element, and a slab. The flow path includes a first flow path end and an opposite second flow path end, and is adapted to allow a fluid to flow through the air venting device. The frame is located in the second end of the flow path. The flexible element and the movable element are located in the frame in a manner such that one end of the flexible element is attached to the first end of the frame and second end of the flexible element is attached to the movable element. The slab is located in the second end of the frame in a manner such that the movable element abuts the slab.

This application claims priority under 35 U.S.C. § 119 to patent application number IN 201641040878 filed on Nov. 30, 2016 in India, the disclosure of which is incorporated herein by reference in its entirety.

### FIELD OF THE INVENTION

The invention here relates to an air venting device for a filter.

### BACKGROUND OF THE INVENTION

Selective Catalytic Reduction system is a technology used in diesel engines to reduce NOx emissions by having chemical reaction between aqueous urea solution and exhaust gas. The hydraulic circuit of selective catalytic reduction system consists of storage tank, pump, filters, valves, hose and spraying device and aqueous urea solution as working medium. In present system, the supply module pumps the working medium to the dosing module. Before pumping the working medium, the working medium is filtered so that to ensure that the clean working medium is supplied to the dosing module. The main filter is permanently fixed or welded with carrier assembly which holds the level sensor and then the carrier assembly is fitted to the tank. During the testing process of vehicle in the assembly plant, the selective catalytic reduction system is supposed to build the required system pressure within specified time which is the threshold value to pass the general criteria for all vehicles but the system fails. This failure is dependent on various parameters.

The U.S. Pat. No. 5,951,862 discloses a filter. Here the filter comprises a filter cartridge located within a housing. Fuel flows through a filter medium of the cartridge, in use, from an outer chamber to an inner chamber. From the inner chamber, the fuel flows over and around a sedimentation baffle located within a sedimentation chamber. Fuel exits the sedimentation chamber through an outlet passage, an air collection chamber being arranged to collect air from the flow of fuel. Air exits the air collection chamber via openings.

### SUMMARY OF THE INVENTION

A first embodiment of the present invention includes an air venting device for a filter. The air venting device includes a flow path, a frame, a movable element, a flexible element, and a slab. The flow path includes a first flow path end and an opposite second flow path end, and is configured to allow a fluid to flow through the air venting device. The frame is located in the second flow path and includes a first frame end and a second frame end. The movable element is located in the frame. The flexible element is located in the frame and includes a first flexible element end attached to the first frame end and a second flexible element end attached to the movable element. The slab is located in the second frame end. The movable element abuts the slab.

A further embodiment of the present invention includes a filter for a selective catalytic reduction (SCR) system. The filter includes a filter housing and an air venting device. The filter housing is configured to enable a fluid to flow from the filter. The air venting device includes a flow path, a frame, a movable element, a flexible element, and a slab. The flow path includes a first flow path end and an opposite second flow path end, and is configured to allow a fluid to flow through the air venting device. The frame is located in the second flow path and includes a first frame end and a second frame end. The movable element is located in the frame. The flexible element is located in the frame and includes a first flexible element end attached to the first frame end and a second flexible element end attached to the movable element. The slab is located in the second frame end. The movable element abuts the slab.

### BRIEF DESCRIPTION OF THE ACCOMPANYING DRAWINGS

An exemplifying embodiment of the invention is explained in principle below with reference to the drawings. The drawings are,

FIG. 1 illustrates an air venting device 100 for a filter 200 according to an embodiment of an invention; and

FIG. 2 illustrates a view of a filter 200 according to an embodiment of an invention.

### DETAILED DESCRIPTION OF THE INVENTION

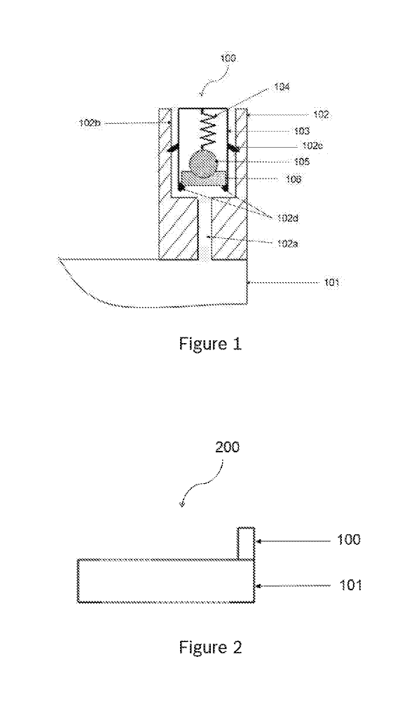

FIG. 1 shows an air venting device 100 for a filter 200. The air venting device 100 comprises a flow path 102, a frame 103, a flexible element 104, a movable element 105 and a slab 106. The flow path 102 adapted to allow a fluid to flow through the air venting device 100. The frame 103 is located in a second end 102b of the flow path 102. A flexible element 104 and a movable element 105 is located in the frame 103 in a manner such that one end of the flexible element 104 is attached to one end of the frame 103 and second end of the flexible element 104 is attached to the movable element 105 and the slab 106 is located in the second end of the frame 103 in a manner such that the movable element 105 abuts the slab 106.

In the air venting device 100, the flexible element 104 is a spring element and one end of the spring element is attached to the first end of the frame 103 and other end of the spring element is attached to the movable element 105. The movable element 105 is a structure made up of material which is compatible for the fluid. For example if the fluid is Ad blue then the compatible material for movable element 102d is HNBR i.e. hydrogenated nitrile butadiene rubber. Also the fluid disclosed as above refers to air, liquid or any other liquid variants.

In the air venting device 100, the first end 102a of the flow path 102 is adapted to have first diameter and second end 102b of the flow path 102 adapted to have second diameter. The diameters of both the first end 102a and the second end 102b of the flow path 102 are different and the diameter of the second end 102b of the flow path 102 is larger than the diameter of the first end 102a of the flow path 102 so that the frame 103 can be easily located in the second end 102b of the flow path 102.

According to an embodiment of this disclosure, in the air venting device 100, the frame 103 is locked to the second end 102b of the flow path 102 by a locking means 102c. Here the locking means 102c can be for example a snap fit lock which locks the frame 103 to the second end 102b of the flow path 102 from inside. The locking means 102c can be any means which is capable to lock the frame 103 to the second end 102b of the flow path 102 from inside. For example the locking means 102c is a screw and preferably the locking means 102c is located in between the second end 102b of the flow path 102 and the frame 103.

According to an embodiment of this disclosure, the frame 103 has at least two protrusions 102d to hold the slab 106. Here the protrusions 102d are the extensions from the frame 103 so that the slab 106 can be held easily on the extensions. Also the slab 106 is a salt slab which can be dissolved easily into the fluid.

According to an embodiment of this disclosure, the slab 106 is adapted to hold the movable element 105 when the flexible element 104 is in the compressed state. The movable element 105 is held by the slab 106. One end of the flexible element 104 is attached to the movable element 105 on one side and the second side of the movable element 105 is free and therefore held by the slab 106. Also the flexible element 104 is in the compressed state when the slab 106 is holding the movable element 105.

The flexible element 104 is adapted to expand and contract based on the movement of the movable element 105. Also as described above the slab 106 is a salt slab which can dissolve into the fluid. So when the slab 106 comes in contact with the fluid it dissolves and then the movable element 105 due to pre-tensioned force of flexible element 104, starts moving down and finally seals the first end 102a of the flow path 102.

FIG. 2 shows a filter 200 for a selective catalytic reduction system. The filter 200 comprises a filter housing 100 for a fluid to flow. The filter 200 further comprises an air venting device 100. The air venting device 100 comprises a flow path 102, a frame 103, a flexible element 104, a movable element 105 and a slab 106. The flow path 102 is adapted to allow the fluid to flow through an air venting device 100 from the filter housing 101. The frame 103 is located in the second end 102a of the flow path 102. The flexible element 104 and the movable element 105 is located in the frame 103 in a manner such that one end of the flexible element 104 is attached to the first end of the frame 103 and second end of the flexible element is attached to the movable element 105 and the slab 106 is located in the second end of the frame 103 in a manner such that the movable element 105 abuts the slab 106.

The main aim of the air venting device in accordance with this disclosure is to vent the trapped air out from the filter 200 during final testing of the vehicle. This is a onetime process. By doing this, the selective catalytic reduction system of a vehicle will be able to build the required pressure for example 1.5 bar in a limited time which is say 120 seconds.

When the fluid is filled inside the filter 200 for the first time, the trapped air from the filter 200 starts moving upwards in the air venting device 100 via the first end 102a of the flow path 102 and as the volume of the fluid increases the trapped air is vacated from the filter 200 via air venting device 101. As the volume of the fluid increases, the fluid from filter housing 101 flows to the air venting device 100 and touches the slab 106 where the slab 106 dissolves in the fluid and the movable element 105 held by the slab 106 moves down and blocks the first end 102a of the flow path 102. One the air venting device 100 is blocked, the fluid starts flowing to the system of the vehicle. This blockage of air venting device 100 will be for the entire life time of the selective catalytic reduction system of the vehicle.

It must be understood that the embodiments explained in the above detailed description in only illustrative and does not limit the scope of this invention. The scope of this invention is limited only by the scope of the claims. Many modification and changes in the embodiments aforementioned are envisaged and are within the scope of this invention.

1. An air venting device for a filter, comprising:
a flow path including a first flow path end and an opposite second flow path end, the flow path configured to allow a fluid to flow through the air venting device;
a frame located in the second flow path end and including a first frame end and a second frame end;
a movable element located in the frame;
a flexible element located in the frame and including a first flexible element end attached to the first frame end and a second flexible element end attached to the movable element; and
a slab located in the second frame end,
wherein the movable element abuts the slab.

2. The air venting device as claimed in claim 1, wherein:
the first flow path end has a first diameter;
the second flow path end has a second diameter; and
the first diameter is different from the second diameter.

3. The air venting device as claimed in claim 1, wherein the frame is locked to the second flow path end by a locking element.

4. The air venting device as claimed in claim 1, wherein the frame further includes at least two protrusions configured to holds the slab.

5. The air venting device as claimed in claim 1, wherein, in response to the flexible element being in a compressed state, the slab is configured to hold the movable element.

6. The air venting device as claimed in claim 1, wherein the flexible element is configured to expand and contract based on movement of the movable element.

7. A filter for an selective catalytic reduction system, comprising:
a filter housing configured to enable a fluid to flow from the filter; and
an air venting device including:
a flow path including a first flow path end and an opposite second flow path end, the flow path configured to allow the fluid to flow through the air venting device from the filter housing;
a frame located in the second flow path end and including a first frame end and a second frame end;
a movable element located in the frame
a flexible element located in the frame and including a first flexible element end attached to the first frame end and a second flexible element end attached to the movable element; and
a slab located in the second frame end such that the movable element abuts the slab.
